(19) United States
(12) Patent Application Publication
(10) Pub. No.: US 2006/0097673 A1
(43) Pub. Date: May 11, 2006

(54) AC power supplying apparatus for vehicles

(75) Inventor: Jae-Beom Jun, Yongin-si (KR)

Correspondence Address: GREENBLUM & BERNSTEIN, P.L.C., 1950 ROLAND CLARKE PLACE, RESTON, VA, 20191, US

(73) Assignee: Hyundai MOBIS Co., Ltd., Seoul (KR)

(21) Appl. No.: 11/046,856

(22) Filed: Feb. 1, 2005

(30) Foreign Application Priority Data
Oct. 15, 2004 (KR) 10-2004-0082686

(51) Int. Cl. H02P 1/00

(52) U.S. Cl. 318/139

(57) ABSTRACT

An AC power supplying apparatus for vehicles includes a battery mounted within an interior of a vehicle, a direct current-alternating current (DC-AC) inverter including a plurality of switching elements that convert a direct current power source of the battery to an alternating current power source, an outlet mounted within the interior of the vehicle and connected to an output terminal of the DC-AC inverter, a voltage detecting unit that detects a voltage of the output terminal of the DC-AC inverter, a microcomputer that allows a predetermined voltage to be controllably outputted according to the detected voltage, and a driving circuit that turns on and off the switching elements of the DC-AC inverter according to the control of the microcomputer.

### CROSS-REFERENCE TO RELATED APPLICATIONS

The present application is based on, and claims priority from, Korean Application Serial Number 10-2004-0082686, filed on Oct. 15, 2004, the disclosure of which is hereby incorporated by reference herein in its entirety.

### FIELD OF THE INVENTION

The present invention relates to AC power supplying apparatus for vehicles, and more particularly to an AC power supplying apparatus for vehicles constructed to be connected in a vehicle to electronic appliances for operation thereof

### BACKGROUND OF THE INVENTION

Generally, in order to use electronic appliances or measuring instruments in a vehicle, cigar jacks, pre-charged measuring instruments or batteries has been used. In other words, an electronic appliance is connected to a cigar jack via a cord to receive an electric power of a battery or a generator for use in a vehicle. Meanwhile, frequency of using electronic appliances in a vehicle is on the increase these days.

However, there arises an inconvenience of buying an electronic appliance equipped with a gadget connectable to a cigar jack. There is another inconvenience in that testing of electronic apparatus in a vehicle cannot be conducted if a battery in the vehicle is completely discharged.

### SUMMARY OF THE INVENTION

The present invention is disclosed to solve the afore-mentioned problems and it is an object of the present invention to provide an alternating current (AC) power supplying apparatus for vehicles configured to supply an electric power source to AC electronic appliances in a vehicle for operation thereof.

In accordance with a preferred embodiment of the present invention, the AC power supplying apparatus for vehicles comprises a battery mounted within an interior of a vehicle. A direct current-alternating current (DC-AC) inverter includes a plurality of switching elements for converting a direct current power source of the battery to an alternating current power source. An outlet is mounted within the interior of the vehicle and connected to an output terminal of the DC-AC inverter. A voltage detecting unit detects a voltage of the output terminal of the DC-AC inverter A microcomputer allows a predetermined voltage to be controllably outputted according to the detected voltage. A driving circuit turns on and off the switching elements of the DC-AC inverter according to the control of the microcomputer.

### BRIEF DESCRIPTION OF THE DRAWINGS

For a better understanding of the nature and objects of the present invention, reference should be made to the following detailed description with the accompanying drawings, in which:

FIG. 1 is a schematic drawing for illustrating how an outlet is installed inside a vehicle according to an embodiment of the present invention;

FIG. 2 is a schematic block diagram for illustrating an alternating current power supply apparatus according to an embodiment of the present invention; and

FIG. 3 is a detailed circuit drawing of the alternating current power supply apparatus of FIG. 2.

### DETAILED DESCRIPTION OF THE PREFERRED EMBODIMENT

The preferred embodiment of the present invention will now be described in detail with reference to the annexed drawings, where the present embodiment is not limiting the scope of the present invention but is given only as an illustrative purpose.

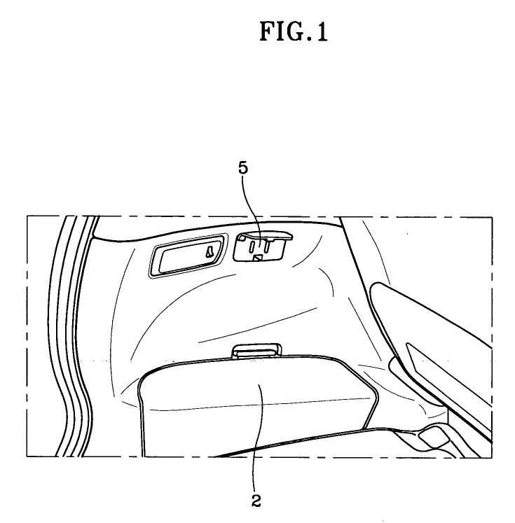

Referring to FIG. 1, a vehicle is disposed therein with a battery pack accommodating unit 2 for accommodating a battery pack in a trunk of the vehicle and an outlet 5 for electrically connected to the battery pack accommodating unit 2. Although it is not depicted in the drawing, it is preferred that outlets 5 are respectively installed at a lateral surface of a front seat and also at a lateral surface of a back seat of the vehicle.

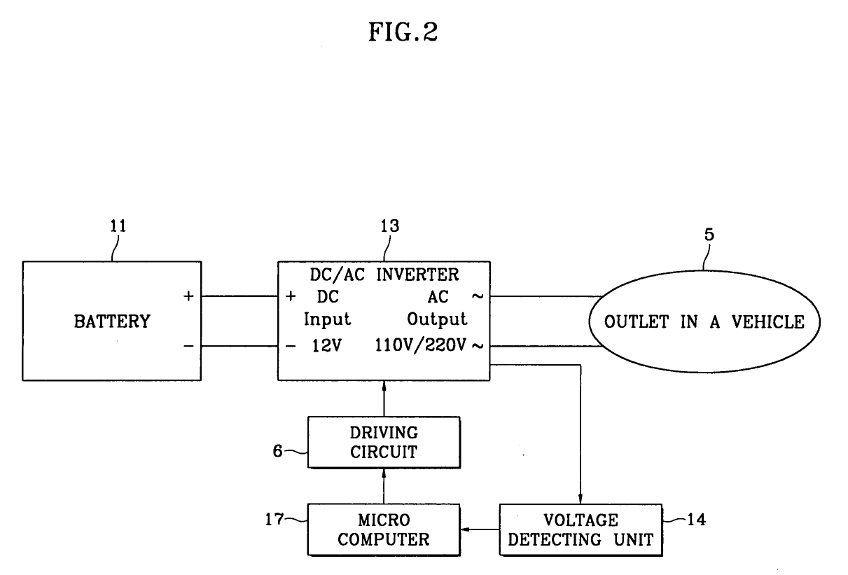

Now referring to FIG. 2, an AC/DC power supply apparatus provided at the battery pack accommodating unit 2 includes a battery 11; a direct current-alternating current DC-AC inverter 13; a voltage detecting unit 14 connected to the DC-AC inverter 13 for detecting a voltage outputted from an output terminal of the DC-AC inverter 13; a microcomputer 17 for outputting a control signal according to the detected voltage to generate a predetermined voltage of AC power source; and a driving circuit 6 for driving the DC-AC inverter 13 according to the control signal of the microcomputer 17.

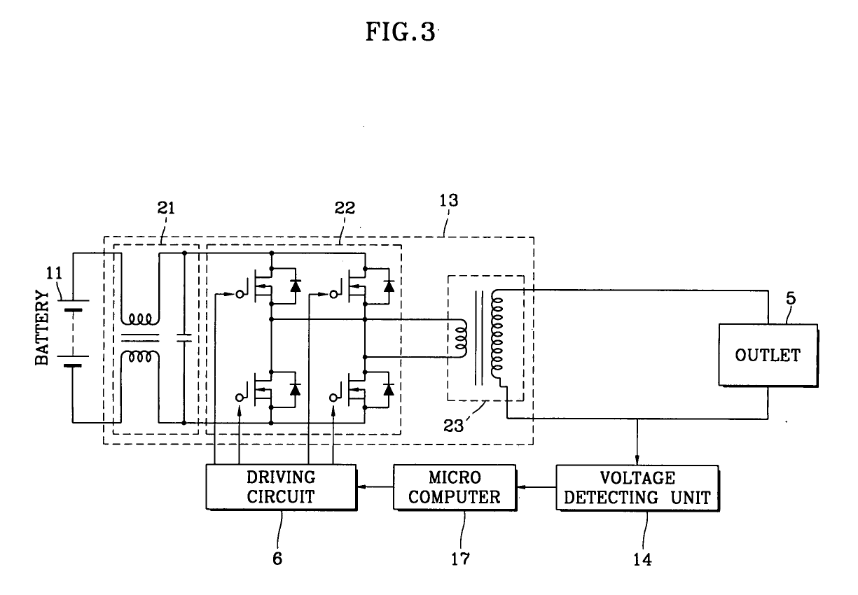

Now referring to FIG. 3, the DC-AC inverter 13 connected to ‘+’ and ‘−’ terminals of the battery 11 includes a DC input filter 21, a switching circuit 22 comprised of a plurality of switching elements connected to the DC input filter 21 and a transformer 23 connected to the switching circuit 22.

Furthermore, the voltage outputted from the output terminal of the DC-AC inverter 13 is detected by the voltage detecting unit 14 to be input to the microcomputer 17, where the microcomputer 17 controls ON/OFF of the switching elements (MOS FET) of the DC-AC inverter 13 via the driving circuit 6 according to the detected voltage to generate an AC power source of a predetermined voltage (for example, a voltage established via an input device by a user).

According to the construction thus described, a battery pack is mounted at an accommodating unit within the vehicle to be connected with the DC-AC inverter equipped at the accommodating unit, and the outlet connected to the DC-AC inverter is provided in a trunk or in an interior of the vehicle, by which electronic appliances can be connected to the outlet to allow AC power source to be used. Furthermore, a power source detecting unit is connected to an output terminal of the DC-AC inverter to allow an AC power source desired by a user to be outputted, and DC-AC inverter can be controlled while the output voltage can be checked by the power source detecting unit.

The foregoing description of the preferred embodiment of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

As apparent from the foregoing, there is an advantage in the AC power supplying apparatus for vehicles thus described according to the embodiment of the present invention in that an AC power can be supplied to an AC power electronic appliance in a vehicle.

1. An AC power supplying apparatus for vehicles comprising:
a battery mounted within an interior of a vehicle;
a direct current-alternating current (DC-AC) inverter including a plurality of switching elements that convert a direct current power source of the battery to an alternating current power source;
an outlet mounted within the interior of the vehicle and connected to an output terminal of the DC-AC inverter;
a voltage detecting unit that detects a voltage of the output terminal of the DC-AC inverter;
a microcomputer that allows a predetermined voltage to be controllably outputted according to the detected voltage; and
a driving circuit that turns on and off the switching elements of the DC-AC inverter according to the control of the microcomputer.

2. The apparatus as defined in claim 1, wherein the DC-AC inverter is mounted at a battery accommodating unit located in a trunk of a vehicle.
